(19) United States
(12) Patent Application Publication
(10) Pub. No.: US 2006/0285497 A1
(43) Pub. Date: Dec. 21, 2006

(54) Method, apparatus and computer program product providing interoperable QoS parameters and signaling thereof in a 3GPP2-3GPP and 3GPP2-3GPP2 conversational multimedia exchange

(75) Inventors: Keith Miller, Plano, TX (US); Igor Danilo Diego Curcio, Tampere (FI); Umesh Chandra, Allen, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/432,981

(22) Filed: May 11, 2006

Related U.S. Application Data
(60) Provisional application No. 60/692,709, filed on Jun. 20, 2005.

(51) Int. Cl. H04L 12/26; H04L 12/56

(52) U.S. Cl. 370/236; 370/395.21

(57) ABSTRACT

A method, electronic device and computer program product are provided to enable an initiator of a multimedia call to signal at least one QoS parameter to a called party. The method includes: obtaining at least one flow_profile_ID; performing calculations to convert the at least one flow_profile_ID to at least one QoS parameter of the called party; and sending the at least one QoS parameter to the called party.

### CROSS-REFERENCE TO RELATED APPLICATIONS

This patent application claims priority under 35 U.S.C. §119(e) from Provisional Patent Application No. 60/692,709, filed Jun. 20, 2005, the disclosure of which is incorporated by reference herein in its entirety.

### TECHNICAL FIELD

The exemplary and non-limiting embodiments of this invention relate generally to wireless communications systems, devices and methods and, more specifically, relate to systems, devices and methods for performing multimedia wireless communications.

### BACKGROUND

Various abbreviations that may appear herein are defined as follows:

| | |
|---|---|
| 3GPP: | 3rd Generation Partnership Project |
| 3GPP2: | 3rd Generation Partnership Project 2 |
| E2E: | End-to-End |
| FL: | Forward Link |
| GSM: | Global System for Mobile Communication |
| IP: | Internet Protocol |
| QOS: | Quality of Service |
| MMD: | All-IP MultiMedia Domain |
| MS: | Mobile Station |
| MT: | Mobile Terminal |
| PSVT: | Packet Switched Video Telephony |
| RAN: | Radio Access Network |
| RL: | Reverse Link |
| RTCP: | Real Time Control Protocol |
| SIP: | Session Initiation Protocol |
| SDP: | Session Description Protocol |
| SWIS: | See What I See |
| UE: | User Equipment |
| UMTS: | Universal Mobile Telecommunications System |
| VoIP: | Voice over IP |

3GPP2 has adopted the method of flow_profile_ID for establishing QoS in the RAN for IP multimedia communications including: VoIP, PSVT and Mobile-to-Mobile Multimedia Streaming. A flow_profile_ID (or “QoS setting”) may be assigned to individual flows or to an ensemble of flows, as well as asymmetrically for FL and RL traffic. Although the user device, referred to variously as a MS, MT or UE, depending on the context, is aware of its local flow_profile_ID(s), it cannot be aware of the flow_profile_ID(s) of the other party and thus cannot be aware of the E2E QoS.

Similarly 3GPP has defined in its technical specification (see 3GPP Technical Specification TS 23.107 QoS Concept and Architecture) the overall concept and architecture for QoS in 3G mobile communications. In this technical specification four traffic classes have been defined (conversational, streaming, interactive and background), along with associated parameters such as delay, error rate, guaranteed bit rate and maximum bit rate. Reference with regard to 3GPP signaling may be made to 3GPP Contribution TD S4-050341 “End-to-end signaling of QoS parameters for IMS multimedia sessions in CS-IMS combinational services (CSICS)”, May 9-13, 2005, Nokia.

### SUMMARY

In an exemplary aspect of the invention, a method is provided to enable an initiator of a multimedia call to signal at least one QoS parameter to a called party. The method includes: obtaining at least one flow_profile_ID; performing calculations to convert the at least one flow_profile_ID to at least one QoS parameter of the called party; and sending the at least one QoS parameter to the called party.

In another exemplary aspect of the invention, an electronic device is provided to enable an initiator of a multimedia call to signal at least one QoS parameter to a called party. The electronic device includes: at least one memory; and a transceiver coupled to at least one data processor, wherein the at least one data processor is coupled to the at least one memory, wherein the at least one data processor is configured to execute a program of machine-readable instructions. The program is capable of performing the operations of: obtaining at least one flow_profile_ID; performing calculations to convert the at least one flow_profile_ID to at least one QoS parameter of the called party; and sending the at least one QoS parameter to the called party.

In a further exemplary aspect of the invention, a computer program product is provided to enable an initiator of a multimedia call to signal at least one QoS parameter to a called party. The computer program product includes program instructions embodied on a tangible computer-readable medium. Execution of the program instructions results in operations including: obtaining at least one flow_profile_ID; performing calculations to convert the at least one flow_profile_ID to at least one QoS parameter of the called party; and sending the at least one QoS parameter to the called party.

In another exemplary aspect of the invention, a method is provided. The method includes: a sender party of a multimedia session informing a called party of its negotiated QoS parameters for the multimedia session; called party negotiating similar QoS attributes with its network; and the called party exchanging the similar QoS attributes with the sender during a session set up phase.

In a further exemplary aspect of the invention, an electronic device is provided. The electronic device includes: at least one memory; and a transceiver coupled to at least one data processor, wherein the at least one data processor is coupled to the at least one memory, wherein the at least one data processor is configured to execute a program of machine-readable instructions. The program is capable of performing the operations of: a sender party of a multimedia session informing a called party of its negotiated QoS parameters for the multimedia session; called party negotiating similar QoS attributes with its network; and the called party exchanging the similar QoS attributes with the sender during a session set up phase.

In another exemplary aspect of the invention, a computer program product is provided. The computer program product includes program instructions embodied on a tangible computer-readable medium. Execution of the program instructions results in operations including: a sender party of a multimedia session informing a called party of its negotiated QoS parameters for the multimedia session; called party negotiating similar QoS attributes with its network; and the called party exchanging the similar QoS attributes with the sender during a session set up phase.

In a further exemplary aspect of the invention, a method is provided to enable an initiator of a multimedia call to signal at least one QoS parameter to a called party. The method includes: means for obtaining at least one flow_profile_ID; means for performing calculations to convert the at least one flow_profile_ID to at least one QoS parameter of the called party; and means for sending the at least one QoS parameter to the called party.

In another exemplary aspect of the invention, a method is provided. The method includes: means for a sender party of a multimedia session informing a called party of its negotiated QoS parameters for the multimedia session; means for the called party negotiating similar QoS attributes with its network; and means for the called party exchanging the similar QoS attributes with the sender during a session set up phase.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows E2E signaling of equivalent 3GPP2 flow_Profile_ID to a 3GPP party during IP call setup in accordance with a first aspect of this invention (3GPP2-3GPP);

FIG. 2 shows E2E signaling of a 3GPP2 flow_Profile_ID at IP call setup in accordance with a further aspect of this invention (3GPP2-3GPP2);

FIG. 3 shows a mobile terminal in the context of a wireless communications system, and illustrates one suitable technical environment for implementing various non-limiting embodiments of the invention;

FIG. 4 is a logic flow diagram that illustrates a method for practicing the exemplary embodiments of the invention; and

FIG. 5 depicts a logic flow diagram of another method for practicing the exemplary embodiments of the invention.

### DETAILED DESCRIPTION

One example of this invention relates to a technique for use in heterogeneous calls (3GPP2 to 3GPP) wherein conversion between the QoS types, and signaling of the QoS parameters, is employed.

Disclosed in accordance with non-limiting aspects of this invention is a technique for signaling 3GPP2 QoS support using standardized call set-up and negotiation/re-negotiation procedures for use in, for example, SIP (IETF RFC 3261 “SIP: Session Initiation Protocol”), SDP (IETF RFC 2327 “SDP: Session Description Protocol”) and MMD (3GPP2 Technical Specification X.S0013 “All-IP Core Network Multimedia Domain”).

As will be described in detail below, various exemplary embodiments of this invention relate generally to the field of IP multimedia communication between a party in a 3GPP2 network (cdma2000) and a party in a 3GPP network (GSM, UMTS). Various exemplary embodiments of this invention relate more specifically to methods, apparatus and computer programs to enhance and optimize QoS in an IP multimedia communication by interpreting the QoS parameters from the 3GPP2 network flow_profile_ID (see 3GPP2 Technical Report C.P1001-E “Administration of Parameter Value Assignments for cdma2000 Spread Spectrum Standards Release E”) or qos_profile_ID (see 3GPP2 Technical Specification X.S0011-004-D “cdma2000 Wireless IP Network Standard: Quality of Service and Header Reduction”) into QoS parameters (e.g., guaranteed bit rate, maximum bit rate and granted delay) that are understood by a 3GPP terminal and network, and further relate to signaling E2E QoS parameters flow_profile_ID or qos_profile_ID negotiated by an initiating terminal (sender party) through the wireless network to the other terminal (called party) in the session. The protocol used for exchanging QoS parameters in certain exemplary embodiments of the invention is SDP, although any other suitable protocol for session set-up may be employed.

Certain exemplary embodiments of this invention permit a receiving 3GPP party (referred to for convenience as a PP called party) in a multimedia call to set-up wireless network resources in an optimal and efficient way according to 3GPP-defined signaling, where the resources comprise those that align to similar QoS settings as defined by 3GPP2 flow_profile_ID(s), and further permit multimedia applications for both the called and calling parties to have a better understanding of the possible operating QoS ranges of the overall (E2E) call.

Certain exemplary embodiments of this invention permit an initiator of the 3G multimedia call in a 3GPP2 network (referred to for convenience as a PP2 sender party) to signal its negotiated QoS parameters flow_profile_ID(s) to the PP called party of the session during the session set-up procedure by mapping flow_profile_ID to 3GPP guaranteed bit rate, maximum bit rate and granted delay. The session set-up may be uni-directional (streaming) or bi-directional (e.g., similar to video conferencing). If the session is bi-directional, the PP called party signals its QoS parameters to the PP2 sender party.

It is understood that SDP and SIP are exemplary protocols, and that the various aspects of this invention may be practiced using protocols other than SDP and SIP. In general, the information between the parties can be transferred using any protocol message at any layer of the ISO OSI stack.

In accordance with non-limiting embodiments, the 3GPP2 party interprets its negotiated flow_profile_ID(s) to the 3GPP QoS parameters 3gpp-guaranteedbitrate, 3gpp-maxbitrate, 3gpp-granteddelay. Reference is also made to the exemplary call control flow diagram shown in FIG. 1, where elements of most interest to this invention are illustrated to be a 3GPP2 terminal 10 (Terminal A), a 3GPP2 network 14 (Network A), a 3GPP network 14 (Network B) and a 3GPP terminal 16 (Terminal B). These elements are each shown to include at least one data processor (DP) 10A, 12A, 14A and 16A and at least one associated memory device or unit (MEM) 10B, 12B, 14B and 16B. Each memory is assumed to store computer program instructions the execution of which by the associated data processor directs operations of the associated network element, including operations in accordance with the non-limiting embodiments of this invention.

The memories 10B, 12B, 14B and 16B may be of any type suitable to the local technical environment and may be implemented using any suitable data storage technology, such as semiconductor-based memory devices, magnetic memory devices and systems, optical memory devices and systems, fixed memory and removable memory. The data processors 10A, 12A, 14A and 16A may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the terminals 10 and 16 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The process begins in this exemplary embodiment with terminal 10 sending a SIP invite to terminal 16 (Step A) to which a response (200 OK) is received (Step B). Terminal 10 then sends a QoS Support request to 3GPP2 network 14 for 48 Kbps media type video and 8 Kbps speech (Step C), and terminal 16 sends a QoS Request to 3GPP network 14 via initial SIP Invite parameters (Step D).

The terminal 10 is assumed to receive from 3GPP2 network 14 a Flow_Profile_ID Grant, (Step E) i.e., it receives a list of negotiated flow_profile_ID(s) for the call. At Step F the 3GPP2 terminal 10 performs a Flow_Profile_ID conversion. In an exemplary embodiment this occurs by calculating the 3GPP guaranteed_bitrate as the sum of the minimum granted bitrates per media type (e.g., audio, video, text), or the minimum bitrate of generic data type (see the examples given below); calculating the 3GPP maximum_bitrate as the sum of the maximum granted bitrates per media type, or the maximum bitrate of a generic data type (see the examples below); and calculating the 3GPP granted_delay as the maximum of the granted delay independent of media type (see the examples below).

At Step G the 3GPP2 terminal 10 sends to the 3GPP terminal 16 as, for example, SDP signals:

a=3gpp-guaranteedbitrate:<guaranteed_bitrate>

a=3gpp-maxbitrate:<maximum_bitrate>

a=3gpp-granteddelay:<granted_delay>,

where it should be noted that these values are not defined for the case where media data and generic data flow_profile_ID(s) are mixed.

Terminal 16 may then optionally renegotiate with network 14 for QoS support (Step H).

Several non-limiting examples are now given to provide a fuller understanding of the operation of these aspects of the invention.

Example 1—Media data related flow_profile_ID(s) (Table 1 from 3GPP2 Technical Report C.R1001-E “Administration of Parameter Value Assignments for cdma2000 Spread Spectrum Standards Release E”, referred to below for simplicity as C.R1001).

The 3GPP2 terminal 10 (Terminal A) desiring to establish a PSVT call is granted the following flow_profile_ID(s) in the 3GPP2 network 12:

0x0100—conversational Rate Set 1 Interactive Speech with no frame bundling;

0x0301—conversational Interactive Video 32K;

0x0302—conversational Interactive Video 40K;

0x0303—conversational Interactive Video 48K; and

0x0500—conversational Media Control Signaling.

Example 1, Part a:

According to C.R1001, associated with 0x0100 is an 8Kbps guaranteed bitrate for speech, and associated with 0x0301, 0x0302, 0x0303 are 32Kbps, 40Kbps and 48Kbps guaranteed bitrates for video.

The DP 10A of terminal 10 calculates the guaranteed_bitrate as:

min {0x0100_audio_bitrate}+min {0x0301_video_bitrate, 0x0302_video_bitrate, 0x0303_video_bitrate} or guaranteed_bitrate=min {8K}+min {32K, 40K, 48K}=40K.

Example 1, Part b:

According to C.R1001, associated with 0x0100 is an 8Kbps guaranteed bitrate for speech and associated with 0x0301, 0x0302, 0x0303 are 32Kbps, 40Kbps and 48Kbps guaranteed bitrates for video.

The DP 10A of terminal 10 calculates the maximum_bitrate as:

max {0x0100_audio_bitrate}+max {0x0301_video_bitrate, 0x0302_video_bitrate, 0x0303_video_bitrate} or maximum_bitrate=max {8K}+max {32K, 40K, 48K}=56K.

Example 1, Part c:

According to C.R1001, associated with 0x0100 is a maximum delay of 100 milliseconds, and associated with 0x0301, 0x0302, 0x0303 is a maximum delay of 200 milliseconds, where it should be noted that these parameters are currently not finalized in C.R1001 and may not exist for all flow_profile_ID(s). In this case the 3GPP2 terminal 10 may choose to use the “0” or “*” for the granted_delay, as defined in the above-referenced copending U.S. Provisional Patent Application No. 60/677,283 filed May 3, 2005, “Signaling Quality of Service (QoS) Parameters for a Multimedia Session”, by Igor Curcio and Umesh Chandra, which is incorporated by reference herein in its entirety.

As stated in the above-referenced copending Curcio et al., by way of example, the 3gpp-granteddelay SDP attribute can also be assigned values of * and 0. A value of * specifies that the delay value is unknown and is unbounded meaning there is no guarantee on the delay values and the packets can experience different amounts of transfer delays. For interactive and background traffic classes, the network does not assign any PDP context transfer delay value which implies its unbounded or best effort depending on the network resources and load. In that case, the SDP attribute can be assigned a value of * or 0.

The DP 10A of terminal 10 calculates the granted_delay as:

max {0x0100_delay, 0x0301_delay, 0x0302_delay, 0x0303_delay} or granted_delay=max {100, 200, 200, 200}=200 ms.

The following SDP messages are signaled to the receiving (called party, the terminal 16 in this case):

a=3gpp-guaranteedbitrate: 40;

a=3gpp-maxbitrate: 56; and

a=3gpp-granteddelay: 200.

Example 2—Generic Data Related flow_profile_ID(s) (Table 2 from C.R1001).

The 3GPP2 terminal 10 (Terminal A) desiring to establish a PSVT call is granted the following flow_profile_ID(s) in the 3GPP2 network 12:

0x0005—generic data, minimum data rate 32K with 100 ms maximum delay;

0x0006—generic data, minimum data rate 64K with 100 ms maximum delay; and

0x0017—generic data, minimum data rate 96K with 500 ms maximum delay.

Example 2, Part a:

The DP 10A of terminal 10 calculates the guaranteed_bitrate as:

min {0x0005_bitrate, 0x0006_bitrate, 0x0017_bitrate} or guaranteed_bitrate=min {32K, 64K, 96K}=32K.

Example 2, Part b:

The DP 10A of terminal 10 calculates the maximum_bitrate as:

max {0x0005_bitrate, 0x0006_bitrate, 0x0017_bitrate} or maximum_bitrate=max {32K, 64K, 96K}=96K.

Example 2, Part c:

The DP 10A of terminal 10 calculates the granted_delay as:

max {0x0005_delay, 0x0006_delay, 0x0017_delay} or granted_delay=max {100, 100, 500}=500 ms.

The following SDP messages are signaled to the receiving (called party, the terminal 16 in this case):

a=3gpp-guaranteedbitrate: 32;

a=3gpp-maxbitrate: 96; and

a=3gpp-granteddelay: 500.

Additionally, a 3GPP2 party (terminal 10) may, upon receiving the guaranteed bitrate, maximum bitrate and granted delay information, request 3GPP2 levels of QoS support based on possible flow_profile_ID bitrates and delays. The terminal 10 may further divide the request according to audio and video by examining the media attribute (m=) of the 3GPP SIP/SDP INVITE.

Example 3, 3GPP Received Parameters

The 3GPP2 terminal 10 receives QoS parameters from a calling 3GPP party (terminal 16) with messages:

a=3gpp-guaranteedbitrate: 32;

a=3gpp-maxbitrate: 96; and

a=3gpp-granteddelay: 500.

In response, the 3GPP2 terminal 10 requests of the 3GPP2 network 12 the generic data flow_profile_ID(s):

0x0005—generic data, minimum data rate 32K with 100 ms maximum delay;

0x0006—generic data, minimum data rate 64K with 100 ms maximum delay; and

0x0007—generic data, minimum data rate 96K with 100 ms maximum delay.

This may be done so that the 3GPP2 terminal 10 can match the range of expected bitrates from the 3GPP party (terminal 16). In this scenario the 3GPP2 terminal 10 has requested the minimum delay because an E2E QoS of less than 750 ms is desired, and at least 500 ms of this timeline may be expected to be consumed by the 3GPP network 14.

A number of advantages can be realized by the use of various ones of the non-limiting embodiments described above. For example, a mobile party in the 3GPP network 14 (GSM, UMTS) may request network resources using 3GPP-native QoS parameters that will closely match the QoS requirements from the calling 3GPP2 party, thus enabling more efficient network resource allocation. Further, the mobile party in the 3GPP2 network 12 (cdma2000) may request network resources using 3GPP2-native QoS parameters that will closely match the QoS requirements from a calling 3GPP party, thus also enabling more efficient network resource allocation. Further, the mobile parties in both the 3GPP2 and 3GPP networks 12 and 14, upon exchange of the QoS information, may more accurately (e.g., at the application level) calculate the total E2E QoS (delay, guaranteed bitrate, and bitrate variation) parameters, since the primary network bottlenecks (the RANs) are bounded. Further, the mobile parties in both the 3GPP2 and 3GPP networks 12 and 14, upon exchange of the QoS information, may allocate application level resources (such as jitter buffer resources) more efficiently. Further still, the mobile parties in both the 3GPP2 and 3GPP networks 12 and 14, upon exchange of the QoS information, may adapt to network variations (e.g., bitrate) more appropriately.

Having thus described several exemplary embodiments of this invention, additional exemplary embodiments will now also be described. These additional exemplary embodiments enable the called party in a 3GPP2 multimedia call to inform the sender party of its negotiated QoS regardless of the nature of the local network, and further enable the use of standardized 3GPP2 QoS mechanisms. These additional exemplary embodiments further enable a party to update other parties during the call of any changes in their component of the QoS.

This aspect of the invention defines new SDP attributes for the above-mentioned flow_profile_ID(s), and the new SDP attributes are carried in SIP messages. The called party may use these SDP attributes to negotiate (or re-negotiate) QoS parameters with its own wireless network. The associated multimedia applications may use these parameters to set application resources, such as jitter buffers, for audio and video media and feedback (RTCP) accordingly.

It is once more noted that SDP and SIP are examples of suitable protocols, and that the practice of the embodiments of the invention is not limited for use with only these protocols.

In accordance with the exemplary embodiments of this invention the sender party of a multimedia session informs the called party of its negotiated QoS parameters for the multimedia session. The called party then negotiates similar QoS attributes with its network and exchanges this value with the sender during the session set up phase. The session set up protocol may be the widely used SIP/SDP signaling protocol for IP session set up, or it may be any other session set up protocol.

An implementation example is given using the SIP/SDP protocols. The SIP INVITE message, which is used to set up a session between two clients, uses SDP to describe the session and media information (the SDP information may be sent in the body of other SIP messages such as 200 OK, ACK or UPDATE). SDP describes the transport information (port and IP address) and media information (such as the codec and the associated parameters). Three new user-defined SDP attributes are defined for indicating the QoS parameters in accordance with is aspect of the invention.

First, an attribute, which may be called “3gpp2-flowprofileid”, is defined in SDP to indicate the flow_profile_ID(s) granted to a terminal by its wireless network in a symmetrical fashion (i.e., same for the FL and the RL). The “3gpp2-flowprofileid” is declared in SDP as:

a=3 gpp2-flowprofileid:<list-of-16-bit-HEX-values-of-granted-flow_profile_IDs>.

Second, an attribute, which may be called “3gpp2-flowprofileid-rl”, is defined in SDP to indicate the flow_profile_ID(s) granted to a terminal by its wireless network in an asymmetrical fashion for the RL. The “3gpp2-flowprofileid-rl” is declared in SDP as:

a=3 gpp2-flowprofileid-rl:<list-of-16-bit-HEX-values-of-granted-RL-flow_profile_IDs>

Or alternatively, the “3gpp2-flowprofileid” is declared in SDP as:

a=3gpp2-flowprofileid:<ascii-char-R, list-of-16-bit-HEX-values-of-granted-RL-flow_profile_IDs>

Third, an attribute, which may be called “3gpp2-flowprofileid-fl”, is defined in SDP that indicates the flow_profile_ID(s) granted to a terminal by its wireless network in an asymmetrical fashion for the FL. The “3gpp2-flowprofileid-fl” is declared in SDP as:

a=3gpp2-flowprofileid-fl:<list-of-16-bit-HEX-values-of-granted-FL-flow_profile_IDs>.

Or alternatively, the “3gpp2-flowprofileid” is declared in SDP as:

a=3gpp2-flowprofileid:<ascii-char-F, list-of-16-bit-HEX-values-of-granted-FL-flow_profile_IDs>

Two non-limiting example sessions are described below, one with symmetrical-only flow_profile_ID(s) and one with both asymmetrical and symmetrical flow_profile_ID(s). Reference in this regard is made to FIG. 2, which is similar in some respects to FIG. 1. Note, however, that in FIG. 2 both network A and B, and terminals A and B, are shown as being of the same type, e.g., 3GPP2.

### EXAMPLE 1

### Symmetrical-Only flow_profile_ID(s)

Assume that Terminal A (sender party, 3GPP2 terminal 10) desires to set up a PSVT call with 48 Kbps video and 8 Kbps speech media and requests QoS support for this call from network 12. Assume further that network 12 grants Terminal A the following flow_profile_ID(s) in a symmetric fashion:

0x0000—conversational Rate Set 1 Interactive Speech with no frame bundling;

0x0301—conversational Interactive Video 32 k;

0x0302—conversational Interactive Video 40 k;

0x0303—conversational Interactive Video 48 k; and

0x0500—conversational Media Control Signaling.

Terminal A includes the following attributes in the initial SIP INVITE message or subsequent SIP UPDATE message (depending on the order of network resource allocation):

a=3gpp2-flowprofileid: 0x0100 0x0301 0x0302 0x0303 0x0500,

as shown in Step G₁ in the SIP UPDATE message sent to 3GPP2 terminal 16.

Additionally, Terminal B (called party, Terminal 16) may request similar QoS support from network 14 using received QoS flow_profile_ID(s) at setup as shown in Step D, or may re-negotiate existing QoS support as shown in Step H.

### EXAMPLE 2

### Symmetrical and Asymmetrical flow_profile_ID(s)

Assume that Terminal A (sender party, 3GPP2 terminal 10) desires to set up a “SWIS like” call (regular VoIP with one way video streaming at 48 Kbps) and requests QoS support for this call from network 12. Network 12 grants the 3GPP2 terminal 10 the following flow_profile_ID(s) in a symmetric fashion:

0x0100—conversational Rate Set 1 Interactive Speech with no frame bundling;

0x0500—conversational Media Control Signaling;

and the following flow_profile_ID(s) in an asymmetric (RL) fashion:

0x0301—conversational Interactive Video 32 k;

0x0302—conversational Interactive Video 40 k; and

0x0303—conversational Interactive Video 48 k.

3GPP2 terminal 10 includes the following attributes in the initial SIP INVITE message or subsequent SIP UPDATE message (depending on the order of network resource allocation):

a=3gpp2-flowprofileid: 0x0100 0x0500; and

a=3gpp2-flowprofileid-rl: 0x0301 0x0302 0x0303 or

a=3gpp2-flowprofileid: R 0x0301 0x0302 0x0303

Additionally, Terminal B (called party, Terminal 16) may request similar QoS support from network 14 using received QoS flow_profile_Id(s) at setup as shown in Step D, or may re-negotiate existing QoS support as shown in Step H. With the modification that received flow_profile_ID(s) received as asymmetrical or requested in the opposite direction, i.e. RL QoS from Terminal A are requested on the FL from Network B and FL QoS from Terminal A are requested on the RL from Network B.

A number of additional advantages can be realized by the use of the further non-limiting embodiments described above. For example, the mobile parties upon exchange of flow_profile_ID information may request network resources from a 3GPP2 network (cdma2000) that are closely matched, and that do not exceed actual resources needed to support E2E calls, or similarly the flow_profile_ID(s) may be converted to 3GPP QoS parameters as previously defined and resources requested with equivalent efficiency from a 3GPP network.

Reference is now made to FIG. 3, in which there is shown as a simplified block diagram an embodiment of a wireless communications system 1 that is suitable for practicing this invention. The wireless communications system 1 includes at least one mobile terminal (MT) 10, it being realized that the terminal 16 in FIGS. 1 and 2 may be similarly constructed. FIG. 3 also shows an exemplary network operator 20 having, for example, a node 30 for connecting to a telecommunications network, such as a Public Packet Data Network or PDN, at least one base station controller (BSC) 40 or equivalent apparatus, and a plurality of base transceiver stations (BTS) 50, also referred to as base stations (BSs), that transmit in a forward or downlink direction both physical and logical channels to the mobile station 10 in accordance with a predetermined air interface standard. A reverse or uplink communication path also exists from the MT 10 to the network operator, which conveys mobile originated access requests and traffic. A cell 3 is associated with each BTS 50, where one cell will at any given time be considered to be a serving cell, while an adjacent cell(s) will be considered to be a neighbor cell. Smaller cells (e.g., picocells) may also be available.

The air interface standard can conform to any suitable standard or protocol, and may enable both voice and data traffic, such as data traffic enabling Internet 70 access and web page downloads. In the exemplary embodiments of this invention the air interface standard can be compatible with a code division multiple access (CDMA) air interface standard, such as cdma2000 (3GPP2), or it may be compatible with a time division multiple access (TDMA) air interface standard, such as GSM (3GPP), although these particular air interface standards are not a limitation upon the practice of the exemplary embodiments of this invention.

The MT 10 typically includes a control unit or control logic, such as a microcontrol unit (MCU) 120 having an output coupled to an input of a display 140 and an input coupled to an output of a user input 160. The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. At least some of this temporary data can be stored in a data buffer 130A. The operating program is assumed, for the purposes of this invention, to enable the MCU 120 to execute the software routines, layers and protocols required to implement the methods in accordance with the invention, and may as well provide a suitable user interface (UI), via display 140 and keypad 160, with a user. Although not shown, a microphone and speaker are typically provided for enabling the user to conduct voice calls in a conventional manner.

The MT 10 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized voice and packet data, is transmitted and received through the antenna 240.

The MT 10 may be employed to implement the terminals 10 and 16 shown in FIGS. 1 and 2, where at least one of the MCU 120 and DSP 180 functions as the DP 10A, 16A, and where the memory 130 functions as the memory 10B, 16B. The user input 160 may include one or more of the following: keypad, keyboard, pointing device, touch-sensitive display screen or voice-sensitive input, as non-limiting examples.

In exemplary embodiments of the invention substantially all SIP/SDP signaling and associated calculations may be performed at the application layer. It is assumed that there exist some application program interface(s) to the lower layers at which the QoS flow_profile_IDs can be requested or obtained. The flow_profile_IDs are negotiated with the network using the QoS_Blob and related procedure described in detail in X.S0011-004-D. This is done on a per-flow basis and enforced by the network. On the 3GPP side (FIG. 1) the QoS parameters may be obtained as part of the packet data protocol (PDP) context activation.

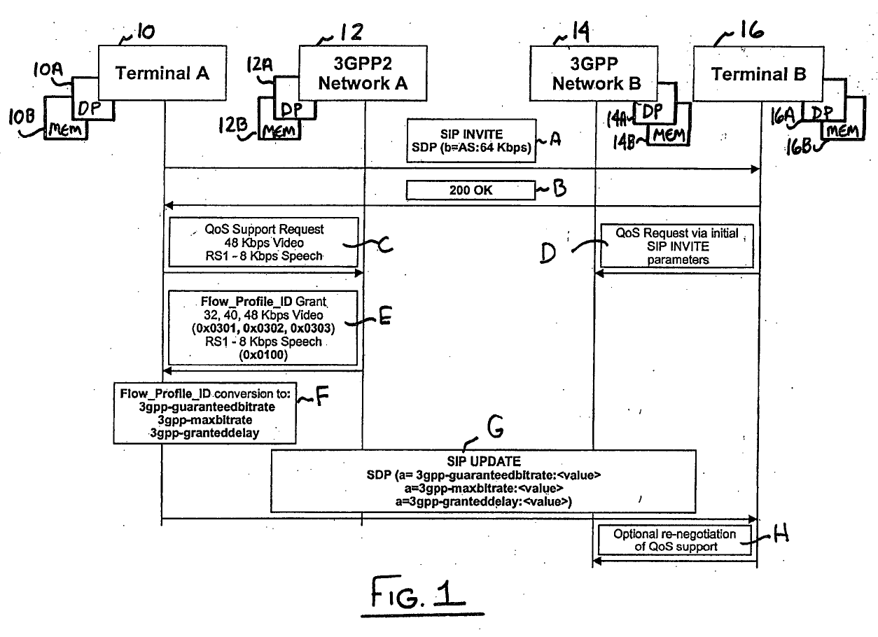

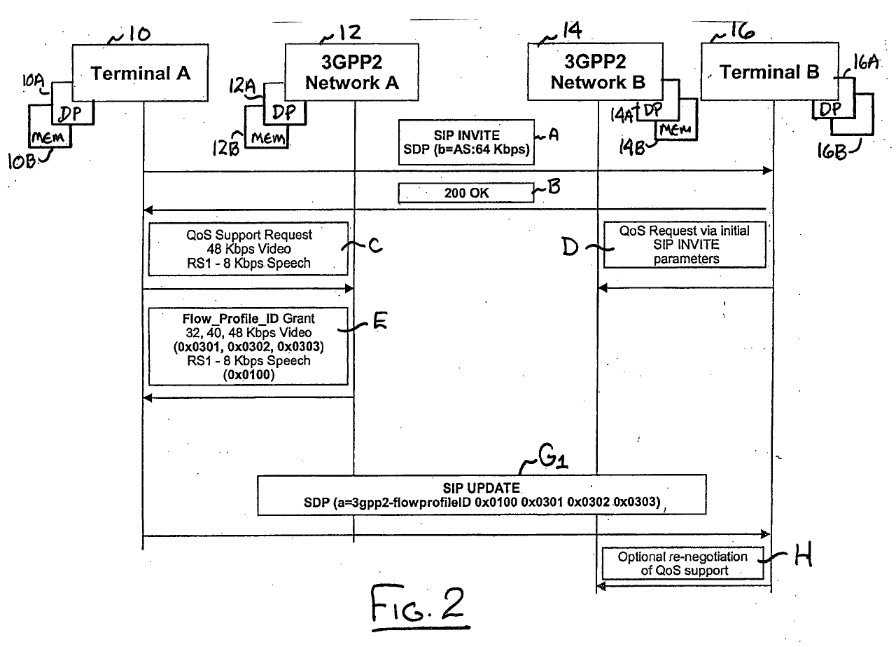

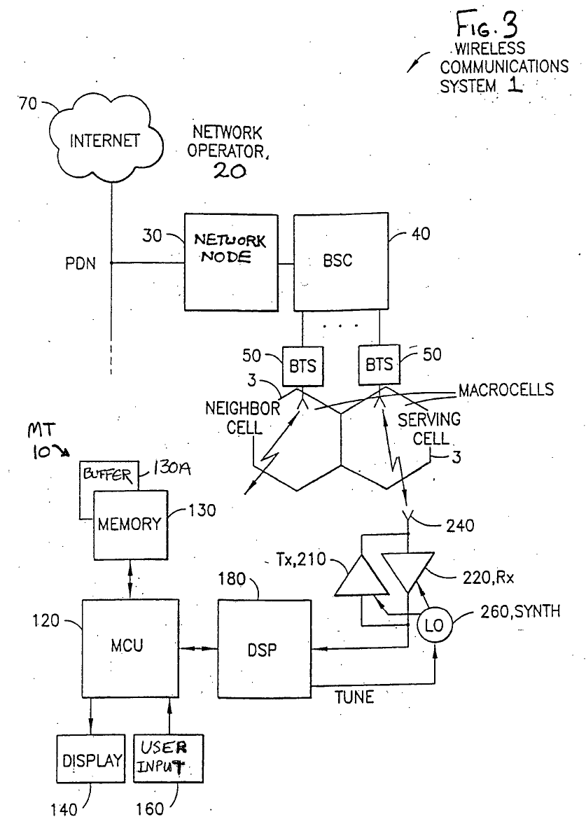

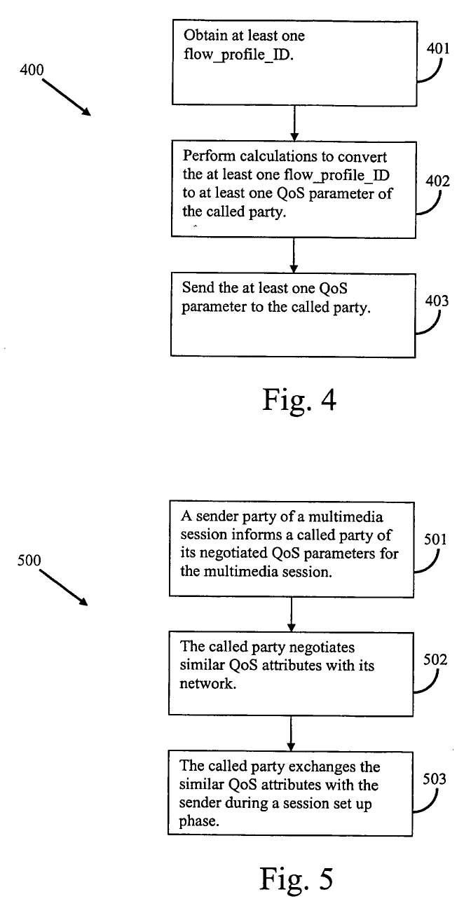

Referring to FIG. 4, a method 400 is shown for practicing the exemplary embodiments of the invention. The method is to enable an initiator of a multimedia call to signal at least one QoS parameter to a called party and includes the following steps. In box 401, at least one flow_profile_ID is obtained. In box 402, calculations are performed to convert the at least one flow_profile_ID to at least one QoS parameter of the called party. In box 403, the at least one QoS parameter is sent to the called party.

Referring to FIG. 5, a further method 500 is shown for practicing the exemplary embodiments of the invention. The method includes the following steps. In box 501, a sender party of a multimedia session informs a called party of its negotiated QoS parameters for the multimedia session. In box 502, the called party negotiates similar QoS attributes with its network. In box 503, the called party exchanges the similar QoS attributes with the sender during a session set up phase.

The Tables 1 and 2 from 3GPP2 Technical Report C.R1001-E “Administration of Parameter Value Assignments for cdma2000 Spread Spectrum Standards Release E” that were referred to above are set forth below:

TABLE 1
Media Data Flow Profile ID samples from 3GPP2 C.R1001-E [1].

| Flow Profile | Flow Profile ID | |
|---|---|---|
| ID (Decimal) | (Hexadecimal) | Flow Description |
| 256 | 0x0100 | Conversational Rate Set 1 Interactive |
| | | Speech with No Frame Bundling |
| 257 | 0x0101 | Conversational Rate Set 2 Interactive |
| | | Speech with No Frame Bundling |
| 258 | 0x0102 | Streaming Rate Set 1 Interactive Speech, |
| | | full rate with No Frame Bundling |
| 259 | 0x0103 | Streaming Rate Set 2 Interactive Speech, |
| | | full rate with No Frame Bundling |
| 260 | 0x0104 | Streaming Rate Set 2 Interactive Speech, |
| | | half rate with No Frame Bundling |
| . . . | . . . | . . . |
| 276-511 | 0x0114-0x01ff | Reserved |
| | 0x0200 | Streaming Audio 16k |
| 513 | 0x0201 | Streaming Audio 24k |
| 514 | 0x0202 | Streaming Audio 32k |
| 515 | 0x0203 | Streaming Audio 48k |
| 516 | 0x0204 | Streaming Audio 64k |
| 517-767 | 0x0205-0x02ff | Reserved |
| | 0x0300 | Conversational Interactive Video 24k |
| 769 | 0x0301 | Conversational Interactive Video 32k |
| 770 | 0x0302 | Conversational Interactive Video 40k |
| 771 | 0x0303 | Conversational Interactive Video 48k |
| 772 | 0x0304 | Conversational Interactive Video 56k |
| 773 | 0x0305 | Conversational Interactive Video 64k |
| . . . | . . . | . . . |
| 780 | 0x030c | Streaming Video 24k |
| 781 | 0x030d | Streaming Video 48k |
| 782 | 0x030e | Streaming Video 64k |
| 783 | 0x030f | Streaming Video 96k |
| 784 | 0x0310 | Streaming Video 120k |
| 785 | 0x0311 | Streaming Video 128k |
| 786-1023 | 0x0312-0x03ff | Reserved |
| 1024 | 0x0400 | Streaming Text (3GPP) |
| 1025-1279 | 0x0400-0x04ff | Reserved |
| 1280 | 0x0500 | Conversational Media Control Signaling |
| 1281 | 0x0501 | Streaming Media Control Signaling |
| 1282 | 0x0502 | Interactive Media Control Signaling |
| 1083-1535 | 0x0503-0x05ff | Reserved |

Note 1:
Maximum Latency will be assigned (along with other parameters) as C.R1001-E is finalized. The values shown in example 1 above are for illustrative purposes at this time.

TABLE 2
Generic Data Flow Profile ID sample from 3GPP2 C.R1001-E [1].

| Flow | Flow Profile | |
|---|---|---|
| Profile ID | ID | |
| (Decimal) | (Hexadecimal) | Flow Description |
| 0 | 0x0000 | best effort |
| 1 | 0x0001 | Streaming 32 kbps |
| 2 | 0x0002 | Streaming 64 kbps |
| 3 | 0x0003 | Streaming 96 kbps |
| 4 | 0x0004 | Streaming 128 kbps |
| 5 | 0x0005 | Minimum Acceptable User Data Rate of 32 kbps, max. latency is 100 msec, 1% avg. data loss rate |
| 6 | 0x0006 | Minimum Acceptable User Data Rate of 64 kbps, max. latency is 100 msec, 1% avg. data loss rate. |
| 7 | 0x0007 | Minimum Acceptable User Data Rate of 96 kbps, max. latency is 100 msec, 1% avg. data loss rate. |
| 8 | 0x0008 | Minimum Acceptable User Data Rate of 144 kbps, max. latency is 100 msec, 1% avg. data loss rate. |
| . . . | . . . | . . . |
| 21 | 0x0015 | Minimum Acceptable User Data Rate of 32 kbps, max. latency is 500 msec, 1% avg. data loss rate. |
| 22 | 0x0016 | Minimum Acceptable User Data Rate of 64 kbps, max. latency is 500 msec, 1% avg. data loss rate. |
| 23 | 0x0017 | Minimum Acceptable User Data Rate of 96 kbps, max. latency is 500 msec, 1% avg. data loss rate. |
| 24 | 0x0018 | Minimum Acceptable User Data Rate of 144 kbps, max. latency is 500 msec, 1% avg. data loss rate. |
| . . . | . . . | . . . |
| 40 | 0x0028 | Minimum Acceptable User Data Rate of 32 kbps, max. latency is 2000 msec, 1% avg. data loss rate. |
| 41 | 0x0029 | Minimum Acceptable User Data Rate of 64 kbps, max. latency is 2000 msec, 1% avg. data loss rate. |
| 42 | 0x002a | Minimum Acceptable User Data Rate of 96 kbps, max. latency is 2000 msec, 1% avg. data loss rate. |
| 43 | 0x002b | Minimum Acceptable User Data Rate of 144 kbps, max. latency is 2000 msec, 1% avg. data loss rate. |
| . . . | . . . | . . . |
| 61-255 | 0x003b-0x00ff | Reserved |

Note 1:
Maximum Latency is defined to be the maximum amount of time allowed from the time that and octet of user data is submitted to the transmitting RLP until the receiving RLP either delivers the octet or aborts its delivery.
Note 2:
Data loss rate is defined as the ratio of the number of lost data octets to the number of transmitted data octets, measured above RLP.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

In addition, the logic flow diagrams of FIGS. 4 and 5 may be viewed as method steps, as operations executed by computer program products, or as interconnected logic blocks for performing the indicated functions.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings. As but some non-limiting examples, the use of other similar or equivalent message protocols, other than SIP and SDP, maybe employed, and the embodiments of the invention may be practiced with other types of QoS parameters if desired. However, all such and similar modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method to enable an initiator of a multimedia call to signal at least one QoS parameter to a called party, comprising:
obtaining at least one flow_profile_ID;
performing calculations to convert the at least one flow_profile_ID to at least one QoS parameter of the called party; and
sending the at least one QoS parameter to the called party.

2. The method of claim 1, wherein the method is employed during a session setup procedure.

3. The method of claim 1, wherein the at least one QoS parameter is sent to the called party as part of a SIP message.

4. An electronic device to enable an initiator of a multimedia call to signal at least one QoS parameter to a called party, comprising:
at least one memory; and
a transceiver coupled to at least one data processor, wherein the at least one data processor is coupled to the at least one memory, wherein the at least one data processor is configured to execute a program of machine-readable instructions capable of performing the operations of:
obtaining at least one flow_profile_ID;
performing calculations to convert the at least one flow_profile_ID to at least one QoS parameter of the called party; and
sending the at least one QoS parameter to the called party.

5. The electronic device of claim 4, wherein the at least one QoS parameter is sent to the called party as part of a SIP message.

6. The electronic device of claim 4, wherein the electronic device is a portable electronic device.

7. The electronic device of claim 4, wherein the electronic device is a cellular telephone.

8. A computer program product enabling an initiator of a multimedia call to signal at least one QoS parameter to a called party comprising program instructions embodied on a tangible computer-readable medium, execution of the program instructions resulting in operations comprising:
obtaining at least one flow_profile_ID;
performing calculations to convert the at least one flow_profile_ID to at least one QoS parameter of the called party; and
sending the at least one QoS parameter to the called party.

9. The computer program product of claim 8, wherein the at least one QoS parameter is sent to the called party as part of a SIP message.

10. A method comprising:
a sender party of a multimedia session informing a called party of its negotiated QoS parameters for the multimedia session;
the called party negotiating similar QoS attributes with its network; and
the called party exchanging the similar QoS attributes with the sender during a session set up phase.

11. The method of claim 10, wherein the similar QoS attributes are exchanged using at least one SDP attribute sent in a body of a SIP message.

12. The method of claim 11, wherein the at least one SDP attribute comprises at least one indicator corresponding to at least one flow_profile_ID granted to a terminal by its wireless network in a symmetrical fashion.

13. The method of claim 12, wherein the at least one SDP attribute is referred to as “3gpp2-flowprofileid” and is declared in SDP as:
a=3gpp2-flowprofileid:<list-of-16-bit-HEX-values-of-granted-flow_profile_IDs>.

14. The method of claim 11, wherein the at least one SDP attribute comprises at least one indicator corresponding to at least one flow_profile_ID granted to a terminal by its wireless network in an asymmetrical fashion for a reverse link.

15. The method of claim 11, wherein the at least one SDP attribute is referred to as “3gpp2-flowprofileid-rl” and is declared in SDP as:
a=3gpp2-flowprofileid-rl:<list-of-16-bit-HEX-values-of-granted-RL-flow_profile_IDs>.

16. The method of claim 15, wherein the at least one SDP attribute is referred to as “3gpp2-flowprofileid” and is declared in SDP as:
a=3gpp2-flowprofileid:<ascii-character-R list-of-16-bit-HEX-values-of-granted-RL-flow_profile_IDs>.

17. The method of claim 11, wherein the at least one SDP attribute comprises at least one indicator corresponding to at least one flow_profile_ID granted to a terminal by its wireless network in an asymmetrical fashion for a forward link.

18. The method of claim 17, wherein the at least one SDP attribute is referred to as “3gpp2-flowprofileid-fl” and is declared in SDP as:
a=3gpp2-flowprofileid-fl:<list-of-16-bit-HEX-values-of-granted-FL-flow_profile_IDs>.

19. The method of claim 17, wherein the at least one SDP attribute is referred to as “3gpp2-flowprofileid” and is declared in SDP as:
a=3 gpp2-flowprofileid:<ascii-character-F list-of-16-bit-HEX-values-of-granted-FL-flow_profile_IDs>.

20. An electronic device comprising:
at least one memory;
a transceiver coupled to at least one data processor, wherein the at least one data processor is coupled to the at least one memory, wherein the at least one data processor is configured to execute a program of machine-readable instructions capable of performing the operations of:
a sender party of a multimedia session informing a called party of its negotiated QoS parameters for the multimedia session;
the called party negotiating similar QoS attributes with its network; and
the called party exchanging the similar QoS attributes with the sender during a session set up phase.

21. The electronic device of claim 20, wherein the similar QoS attributes are exchanged using at least one SDP attribute sent in a body of a SIP message.

22. The electronic device of claim 21, wherein the at least one SDP attribute comprises at least one indicator corresponding to at least one flow_profile_ID granted to a terminal by its wireless network in a symmetrical fashion.

23. The electronic device of claim 22, wherein the at least one SDP attribute is referred to as “3gpp2-flowprofileid” and is declared in SDP as:
a=3gpp2-flowprofileid: <list-of-16-bit-HEX-values-of-granted-flow_profile_IDs>.

24. The electronic device of claim 21, wherein the at least one SDP attribute comprises at least one indicator corresponding to at least one flow_profile_ID granted to a terminal by its wireless network in an asymmetrical fashion for a reverse link.

25. The electronic device of claim 24, wherein the at least one SDP attribute is referred to as “3gpp2-flowprofileid-rl” and is declared in SDP as:
a=3 gpp2-flowprofileid-rl:<list-of-16-bit-HEX-values-of-granted-RL-flow_profile_IDs>.

26. The electronic device of claim 24, wherein the at least one SDP attribute is referred to as “3gpp2-flowprofileid” and is declared in SDP as:
a=3gpp2-flowprofileid:<ascii-char-R list-of-16-bit-HEX-values-of-granted-RL-flow_profile_IDs>.

27. The electronic device of claim 21, wherein the at least one SDP attribute comprises at least one indicator corresponding to at least one flow_profile_ID granted to a terminal by its wireless network in an asymmetrical fashion for a forward link.

28. The electronic device of claim 27, wherein the at least one SDP attribute is referred to as “3gpp2-flowprofileid-fl” and is declared in SDP as:
a=3gpp2-flowprofileid-fl:<list-of-16-bit-HEX-values-of-granted-FL-flow_profile_IDs>.

29. The electronic device of claim 27, wherein the at least one SDP attribute is referred to as “3gpp2-flowprofileid” and is declared in SDP as:
a=3 gpp2-flowprofileid: <ascii-char-F list-of-16-bit-HEX-values-of-granted-FL-flow_profile_IDs>.

30. The electronic device of claim 20, wherein the electronic device is a portable electronic device.

31. The electronic device of claim 20, wherein the electronic device is a cellular telephone.

32. A computer program product comprising program instructions embodied on a tangible computer-readable medium, execution of the program instructions resulting in operations comprising:
a sender party of a multimedia session informing a called party of its negotiated QoS parameters for the multimedia session;
the called party negotiating similar QoS attributes with its network; and
the called party exchanging the similar QoS attributes with the sender during a session set up phase.

33. The computer program product of claim 32, wherein the similar QoS attributes are exchanged using at least one SDP attribute sent in a body of a SIP message.

34. The computer program product of claim 33, wherein the at least one SDP attribute comprises at least one indicator corresponding to at least one flow_profile_ID granted to a terminal by its wireless network in a symmetrical fashion.

35. The computer program product of claim 34, wherein the at least one SDP attribute is referred to as “3gpp2-flowprofileid” and is declared in SDP as:
a=3gpp2-flowprofileid:<list-of-16-bit-HEX-values-of-granted-flow_profile_IDs>.

36. The computer program product of claim 33, wherein the at least one SDP attribute comprises at least one indicator corresponding to at least one flow_profile_ID granted to a terminal by its wireless network in an asymmetrical fashion for a reverse link.

37. The computer program product of claim 36, wherein the at least one SDP attribute is referred to as “3gpp2-flowprofileid-rl” and is declared in SDP as:
a=3gpp2-flowprofileid-rl:<list-of-16-bit-HEX-values-of-granted-RL-flow_profile_IDs>.

38. The computer program product of claim 36, wherein the at least one SDP attribute is referred to as “3gpp2-flowprofileid” and is declared in SDP as:
a=3gpp2-flowprofileid:<ascii-char-R list-of-16-bit-HEX-values-of-granted-RL-flow_profile_IDs>.

39. The computer program product of claim 33, wherein the at least one SDP attribute comprises at least one indicator corresponding to at least one flow_profile_ID granted to a terminal by its wireless network in an asymmetrical fashion for a forward link.

40. The computer program product of claim 39, wherein the at least one SDP attribute is referred to as “3gpp2-flowprofileid-fl” and is declared in SDP as:
a=3 gpp2-flowprofileid-fl:<list-of-16-bit-HEX-values-of-granted-FL-flow_profile_IDs>.

41. The computer program product of claim 39, wherein the at least one SDP attribute is referred to as “3gpp2-flowprofileid” and is declared in SDP as:
a=3gpp2-flowprofileid:<ascii-char-F list-of-16-bit-HEX-values-of-granted-FL-flow_profile_IDs>.

42. A method to enable an initiator of a multimedia call to signal at least one QoS parameter to a called party, comprising:
means for obtaining at least one flow_profile_ID;
means for performing calculations to convert the at least one flow_profile_ID to at least one QoS parameter of the called party; and
means for sending the at least one QoS parameter to the called party.

43. A method comprising:
means for a sender party of a multimedia session informing a called party of its negotiated QoS parameters for the multimedia session;
means for the called party negotiating similar QoS attributes with its network; and
means for the called party exchanging the similar QoS attributes with the sender during a session set up phase.
